(19) United States
(12) Patent Application Publication
(10) Pub. No.: US 2022/0306832 A1
(43) Pub. Date: Sep. 29, 2022

(54) RESIN MOLDED BODY, ARTICLE, METHOD OF MANUFACTURING RESIN MOLDED BODY, AND RESIN COMPOSITION

(71) Applicant: CANON KABUSHIKI KAISHA, Tokyo (JP)

(72) Inventors: Akira Yane, Tokyo (JP); Kento Tsuda, Kanagawa (JP)

(21) Appl. No.: 17/704,655

(22) Filed: Mar. 25, 2022

(30) Foreign Application Priority Data
Mar. 29, 2021 (JP) 2021-054920

(51) Int. Cl. C08K 3/22

(52) U.S. Cl. CPC C08K 3/22; C08K 2003/2272; C08K 2201/005; C08K 2201/01

(57) ABSTRACT

A resin molded body contains a resin, a magnetic powder, and a non-magnetic powder. The non-magnetic powder has an apparent density in the range of 0.70 to 1.0 g/cm³. The non-magnetic powder content is more than 8% by volume and 40% or less by volume.

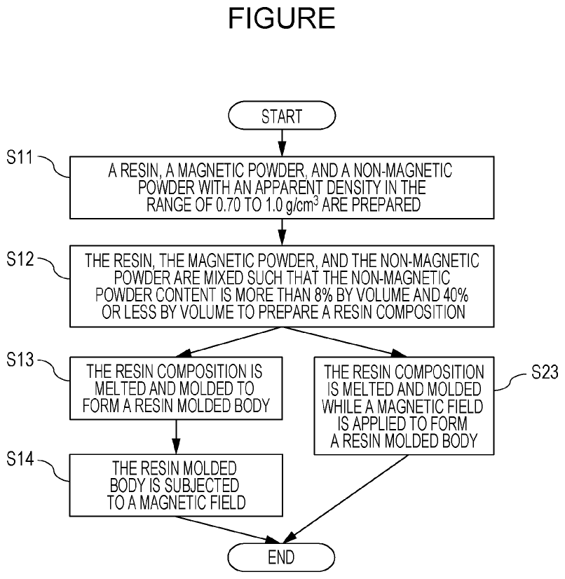

### BACKGROUND OF THE INVENTION

### Field of the Invention

The present disclosure relates to a resin molded body, an article produced using the resin molded body, and a method of manufacturing the resin molded body. The present disclosure also relates to a resin composition serving as a raw material for the resin molded body.

### Description of the Related Art

A resin molded body containing a magnetic powder called a bonded magnet has good magnetic characteristics and processability and is therefore used for various articles, for example, rotating equipment, such as motors, household electrical appliances, OA equipment, and medical equipment. Japanese Patent Laid-Open No. 2016-72406 discloses that a bonded magnet contains a magnetic powder and a non-magnetic powder each having a predetermined particle size to improve the water resistance of the bonded magnet.

Although high dimensional accuracy has been required for bonded magnets in recent years, a bonded magnet disclosed in Japanese Patent Laid-Open No. 2016-72406 has insufficient dimensional accuracy. An increase in the non-magnetic powder content of a bonded magnet to improve the dimensional accuracy, however, results in a decrease in the magnetic powder content and possibly insufficient magnetic characteristics.

### SUMMARY OF THE INVENTION

A resin molded body to solve the above disadvantages contains a resin, a magnetic powder, and a non-magnetic powder, wherein the non-magnetic powder has an apparent density in the range of 0.70 to 1.0 g/cm³, and the non-magnetic powder content is more than 8% by volume and 40% or less by volume.

A method of manufacturing a resin molded body to solve the above problems includes the steps of: preparing a resin, a magnetic powder, and a non-magnetic powder with an apparent density in the range of 0.70 to 1.0 g/cm³; preparing a resin composition by mixing the resin, the magnetic powder, and the non-magnetic powder such that the non-magnetic powder content is more than 8% by volume and 40% or less by volume; melting and molding the resin composition to prepare a resin molded body; and applying a magnetic field to the resin composition and/or the resin molded body.

A resin composition to solve the above problems contains a resin, a magnetic powder, and a non-magnetic powder, wherein the non-magnetic powder has an apparent density in the range of 0.70 to 1.0 g/cm³, and the non-magnetic powder content is more than 8% by volume and 40% or less by volume.

Further features of the present disclosure will become apparent from the following description of exemplary embodiments with reference to the attached drawing.

### BRIEF DESCRIPTION OF THE DRAWINGS

FIGURE is a flow chart of a method of manufacturing a resin molded body according to an embodiment of the present disclosure.

### DESCRIPTION OF THE EMBODIMENTS

Embodiments of the present disclosure are described below.

### Resin Molded Body

A resin molded body according to the present disclosure contains a resin, a magnetic powder, and a non-magnetic powder, wherein the non-magnetic powder has an apparent density in the range of 0.70 to 1.0 g/cm³. The non-magnetic powder content is more than 8% by volume and 40% or less by volume.

It has been known that the molding precision of a resin molded body containing a magnetic powder is improved by replacing part of a resin having a high mold shrinkage factor by a non-magnetic powder. However, replacing part of the magnetic powder by a non-magnetic powder reduces magnetic force. The present inventor found that the magnetic force is not significantly decreased when a predetermined amount of non-magnetic powder in a resin molded body has an apparent density in the range of 0.70 to 1.0 g/cm³. More specifically, it was found that the use of a non-magnetic powder with an apparent density in the above range facilitates the rotational motion of the non-magnetic powder when a magnetic field is applied to a resin molded body containing a magnetic powder, and does not interfere with the orientation of the magnetic powder. Thus, it was found that a resin molded body with good magnetic characteristics and high dimensional accuracy can be provided even when a large amount of non-magnetic powder is added.

A resin, a magnetic powder, and a non-magnetic powder in a resin molded body according to the present disclosure are described below. A resin molded body according to the present disclosure may contain a material other than the resin, the magnetic powder, and the non-magnetic powder. For example, additive agents, such as an oxidation inhibitor and a lubricant, may be contained.

### Resin Composition

A resin composition according to the present disclosure contains a resin, a magnetic powder, and a non-magnetic powder, wherein the non-magnetic powder has an apparent density in the range of 0.70 to 1.0 g/cm³. The non-magnetic powder content is more than 8% by volume and 40% or less by volume. A resin molded body according to the present disclosure is produced by using the resin composition as a raw material. Thus, the resin molded body and the resin composition are composed of the same components. Thus, the description of the components constituting a resin molded body is synonymous with the description of the components constituting a resin composition. A method of manufacturing a resin molded body is described later.

### Resin

A resin in a resin molded body according to the present disclosure is a thermoplastic resin, a thermoplastic elastomer, or a thermosetting resin, for example. Among them, a thermoplastic resin advantageously has a small cure shrinkage when molded and a small dimensional change due to a temperature change.

The thermoplastic resin and the thermoplastic elastomer may be of any type, for example, a polyamide resin, such as polyamide 6, polyamide 66, polyamide 11, polyamide 12, polyamide 612, an aromatic polyamide, a polymerized fatty acid polyamide resin, or a modified polyamide produced by partially modifying these molecules; a linear poly(phenylene sulfide) resin, a cross-linked poly(phenylene sulfide) resin, or a semi-cross-linked poly(phenylene sulfide) resin; a low-density polyethylene, a linear low-density polyethylene resin, a high-density polyethylene resin, a ultra-high molecular weight polyethylene resin, a polypropylene resin, an ethylene-vinyl acetate copolymer resin, an ethylene-ethyl acrylate copolymer resin, an ionomer resin, or a polymethylpentene resin; a polystyrene resin, an acrylonitrile-butadiene-styrene copolymer resin, an acrylonitrile-styrene copolymer resin; a poly(vinyl chloride) resin, a poly(vinylidene chloride) resin, a poly(vinyl acetate) resin, a poly(vinyl alcohol) resin, a poly(vinyl butyral) resin, or a poly(vinyl formal) resin; a methacrylate resin; a poly(vinylidene difluoride) resin, a polychlorotrifluoroethylene resin, a tetrafluoroethylene-hexafluoropropylene copolymer resin, an ethylene-tetrafluoroethylene copolymer resin, a tetrafluoroethylene-perfluoroalkyl vinyl ether copolymer resin, or a polytetrafluoroethylene resin; a polycarbonate resin, a polyacetal resin, a poly(ethylene terephthalate) resin, a poly(butylene terephthalate) resin, a poly(phenylene oxide) resin, a poly(allyl ether sulfone) resin, a poly(ether sulfone) resin, a poly(ether ether ketone) resin, a polyarylate resin, an aromatic polyester resin, a cellulose acetate resin, an elastomer of these resin systems, a single polymer thereof, a random, block, or graft copolymer thereof with another monomer, or an end-group modified product modified with another substance. Examples include polypropylene, polyethylene, poly(vinyl chloride), polyesters, polyamides, polycarbonates, poly(phenylene sulfide), and acrylic resins. In particular, a polyamide, particularly polyamide 12, can be used. Polyamide 12 has a low melting point and a low water absorption rate, is a crystalline resin, and has high moldability. A commercially available polyamide 12 may be UBESTA 3012 or 3014 (manufactured by Ube Industries, Ltd.) or Diamid A1709P or ZZ3000P (manufactured by Daicel-Evonik Ltd.). These thermoplastic resins may be used alone or in combination.

Examples of the thermosetting resin include epoxy resins, phenolic resins, unsaturated polyester resins, urea resins, melamine resins, polyimide resins, allyl resins, and silicone resins.

The resin content of a resin molded body preferably ranges from 8% to 40% by volume. In this range, both good magnetic characteristics and high molding precision can be easily achieved. On the other hand, a resin content of less than 8% by volume may result in a resin composition with high kneading resistance (torque) or low fluidity and difficult to mold. A resin content of more than 40% by volume may result in a low magnetic powder content and difficulty in achieving good magnetic characteristics. The resin content of a resin molded body more preferably ranges from 15% to 35% by volume.

### Magnetic Powder

A resin molded body according to the present disclosure may contain any type of magnetic powder, for example, a ferrite magnetic powder containing ferrite or a rare-earth magnetic powder containing a rare-earth element. Examples of the rare-earth magnetic powder include Nd—Fe—B magnetic powders, Sm—Co magnetic powders, and Sm—Fe—N magnetic powders. In particular, Nd—Fe—B magnetic powders can be used. These magnetic powders may be used alone or in combination.

The Nd—Fe—B magnetic powders contain a cubic compound Nd₂Fe₁₄B as a main phase. The Nd—Fe—B system has a high residual magnetic flux density and can generate high magnetic force even at a low content. The Nd—Fe—B magnetic powders have high mechanical strength, are inexpensive, and are advantageous in terms of cost.

The Nd—Fe—B magnetic powders may contain a rare-earth element other than Nd. Examples of the rare-earth element other than Nd include Pr, Sc, Y, La, Ce, Pm, Sm, Eu, Gd, Tb, Dy, Ho, Er, Tm, Yb, and Lu. The rare-earth elements other than Nd may be used alone or in combination. When Nd and Pr are contained, they may be contained as Di, which is a mixture of these elements. Fe may be partly substituted with Co.

The Nd—Fe—B magnetic powder may contain another element. Examples of the other element include Ti, Zr, Nb, Mo, Hf, Ta, and W. The other elements may be used alone or in combination.

Examples of commercially available Nd—Fe—B magnetic powders include MQP-12-8HD, MQP-10-8.5HD, MQP-12.5-8.5, MQP-11-8, and MQP-8-5 (manufactured by Magnequench), YMM13-9, YMM9-6, and YMM8-4 (manufactured by Yuhong Magnetic Materials Co. Ltd.), and ZRK B-12M, ZRK B-10M, and ZRK-B-8.5M (manufactured by Zhe Jiang Zhao-Ri-Ke Magnet Industries Co., Ltd.).

The magnetic powder content of a resin molded body preferably ranges from 40% to 70% by volume. In this range, both good magnetic characteristics and high molding precision can be easily achieved. On the other hand, a magnetic powder content of less than 40% by volume may result in difficulty in achieving good magnetic characteristics. A resin content of more than 70% by volume may result in a resin composition with high kneading resistance (torque) or low fluidity and difficult to mold.

The magnetic powder preferably has an average particle size in the range of 10 to 100 μm. This range results in low cost and a molded body with high smoothness. On the other hand, an average particle size of less than 10 μm results in an expensive magnetic powder and is undesirable in terms of cost. An average particle size of more than 100 μm may result in a molded body or article with a rough surface, low smoothness, and a poor aesthetic appearance. The average particle size refers to the primary average particle size.

### Non-Magnetic Powder

A non-magnetic powder in a resin molded body according to the present disclosure has an apparent density in the range of 0.70 to 1.0 g/cm³. A non-magnetic powder with an apparent density in this range does not interfere with the orientation of a magnetic powder when a magnetic field is applied to a resin composition and/or a resin molded body to orient the magnetic powder. Consequently, a resin molded body with a desired residual magnetic flux density can be formed even at a non-magnetic powder content of more than 8% by volume. On the other hand, a non-magnetic powder with an apparent density of more than 1.0 g/cm³ is difficult to rotate due to its large mass when a magnetic powder oriented in a magnetic field collides with the non-magnetic powder. Consequently, the magnetic powder is not sufficiently oriented, and a desired residual magnetic flux density cannot be obtained. A non-magnetic powder with an apparent density of less than 0.70 g/cm³ tends to result in low mechanical strength and breakage while kneading or molding. A non-magnetic powder with a broken structure has an increased apparent density, and the magnetic powder is not sufficiently oriented. Thus, a desired residual magnetic flux density cannot be obtained. The apparent density of a non-magnetic powder depends largely on the raw materials, and a plurality of powders can be classified to obtain a desired apparent density.

The non-magnetic powder content of a resin molded body is more than 8% by volume and 40% or less by volume. In this range, the resin molded body has a good mold shrinkage factor and is easy to mold. On the other hand, a non-magnetic powder content of 8% or less by volume results in a relatively high resin content and a high mold shrinkage factor when the resin composition is molded. A non-magnetic powder content of more than 40% by volume results in a relatively low resin content and may result in a resin composition with low fluidity and difficulty in forming a molded body.

The non-magnetic powder preferably has an average particle size in the range of 0.1 to 5 μm. In this range, a resin molded body can be easily formed and has good magnetic characteristics. On the other hand, an average particle size of less than 0.1 μm may result in a non-magnetic powder with a large surface area and a resin composition with low fluidity. A non-magnetic powder with an average particle size of more than 5 μm may interfere with the orientation of the magnetic powder in magnetic field orientation, so that desired magnetic characteristics may not be obtained.

The non-magnetic powder can be composed of inorganic particles. This is due to less deformation and low reactivity caused by heat while the resin composition is kneaded.

The non-magnetic powder can be composed of closed hollow particles. Specific examples include alumina silicate hollow particles, alumina hollow particles, silica hollow particles, mullite hollow particles, and fly ash balloons. In particular, fly ash balloons can be used. Fly ash balloons are inorganic hollow balloons composed mainly of silica alumina. Fly ash balloons have high compressive strength, improve the strength of a resin molded body, and have almost no water absorbency, so that the magnetic powder is unlikely to be oxidized and to have deteriorated magnetic characteristics. Furthermore, fly ash balloons are by-products in a coal-fired power plant, are inexpensive materials, and are advantageous in terms of cost. These non-magnetic powders may be used alone or in combination.

### Article

An article according to the present disclosure is characterized by including the resin molded body. Examples of the article include rotating equipment, such as motors, household electrical appliances, OA equipment, and medical equipment, in which a desired part is placed in a housing. The resin molded body can be used for a housing or a sealing member of these articles, for example. The resin molded body used for the article may have any shape, such as a hexahedron, such as a rectangular parallelepiped or a cube, a cylinder, a sphere, a square column, a cone or pyramid, a circle or ring, a plate, or a sheet.

### Method of Manufacturing Resin Molded Body

A method of manufacturing a resin molded body according to the present disclosure is described below. FIGURE is a manufacturing flow chart of a method of manufacturing a resin molded body according to an embodiment of the present disclosure.

First, a resin, a magnetic powder, and a non-magnetic powder with an apparent density in the range of 0.70 to 1.0 g/cm³ are prepared (S11). The magnetic powder may be subjected to surface treatment to prevent degradation of magnetic characteristics due to oxidation, improve wettability to the resin, and improve the mechanical strength of a molded product. Any chemical conversion treatment agent may be used for the surface treatment, for example, a silane coupling agent, a titanium coupling agent, an aluminum coupling agent, a siloxane polymer, or a phosphoric acid surface treatment agent. These treatments can be performed in combination as required.

Subsequently, the resin, the magnetic powder, and the non-magnetic powder are mixed such that the non-magnetic powder content is more than 8% by volume and 40% or less by volume to prepare a resin composition (S12). A method of preparing the resin composition, that is, a method of compounding these raw materials may be, but is not limited to, a method of melting and shearing a mixture of the raw materials using a screw or a blade as in a single-screw extruder, a twin-screw extruder, or a kneader. Alternatively, the mixture may be passed through a plurality of adjacent rollers, such as a rolling mill, for melting and shearing. If necessary, mixing may be performed in advance with a tumbler, a V-type blender, a Nauta mixer, or a Banbury mixer. The compounded resin composition may be treated to be of a certain size or smaller in order to facilitate handling in a subsequent process. For example, the compounded resin composition may be taken as a lump and ground with a grinder. Furthermore, particles of a certain size have high transferability and measurability and are advantageous for handling in a molding process. For example, a hot cut method or a cold cut method may be used. In the hot cut method, the compounded resin composition continuously discharged from a discharge hole is cut in a molten state. In the cold cut method, the compounded resin composition continuously discharged as a strand from a discharge hole is solidified by air cooling or water cooling and is then finely cut into pellets. In the hot cut method, resin particles after cutting may come into contact with each other and may be bonded together before cooled to a temperature below the melting point. Thus, it is important to adjust the number and position of discharge holes and the speed of cutting teeth. In the cold cut method, at a temperature below the glass transition temperature, the resin may not be cut into pellets and may be broken into pieces. Thus, the resin can be cut at a temperature equal to or higher than the glass transition temperature and lower than the melting point. Furthermore, a strand with an appropriate water content absorbs the impact of cutting and is difficult to break. Thus, water cooling can be used rather than air cooling.

The resin composition is then melted and molded (S13). The molded body is subjected to a magnetic field (S14). The magnetic field may be applied while the resin composition is melted in the molding process instead of after completion of the molding process (S23). In other words, the magnetic field may be applied to the resin molded body or the resin composition.

The resin composition may be melted and molded by any method, for example, injection molding, transfer molding, press forming, extrusion, or compression molding. The molded body may have any desired shape.

The magnetic field may be applied by any method, including the following method. A cavity of a mold of an injection molding machine is filled with a resin composition. While the mold is heated to melt the resin composition, an electric current is passed through a pair of first coils arranged above and below the mold to apply magnetic force. After a molded body is formed, an electric current is passed through a pair of second coils arranged above and below the oriented molded body to further apply a magnetized magnetic field to the oriented molded body. Thus, a resin molded body according to the present disclosure can be formed. Thus, a resin molded body according to the present disclosure is a magnetic field oriented body.

The oriented molded body can be magnetized by a pulse magnetization method, in which a waveform of an electric current to be applied is a pulse shape. The magnetization magnetic field can range from 500 to 1500 kA/m. At a magnetization magnetic field of less than 500 kA/m, the orientation magnetic field is insufficient for the coercive force of the magnetic powder, so that desired magnetic characteristics may not be obtained. On the other hand, at a magnetic field of more than 1500 kA/m, a large current is required to generate an orientation magnetic field, so that the life of the apparatus may be shortened due to disconnection of a coil or the like. The means for applying a magnetic field is not limited to a coil and may be a magnetic material, such as a permanent magnet.

### EXEMPLARY EMBODIMENTS

The present disclosure is more specifically described in the following exemplary embodiments.

First, evaluation methods for a resin composition and a resin molded body are described below.

### Method for Measuring Apparent Density of Non-Magnetic Powder

The apparent density is calculated by dividing the mass of a sample particle by the outer volume of the sample. For a particle with an internal cavity, the internal cavity in the particle is regarded as a cubic content. Although the apparent density can typically be measured by the pycnometer method according to JIS R-1620, the apparent densities in the exemplary embodiments were determined as described below. The cubic content of a sample, the mass of which was measured, was measured with a dry-process automatic densitometer (AccuPyc 1330 manufactured by Micromeritics Instrument Corporation) to calculate the apparent density. The measurement was performed using nitrogen gas at 25° C.

### Method for Measuring Mold Shrinkage Factor of Resin Molded Body

The mold shrinkage factor was determined as described below. Charpy impact test specimens were prepared with an injection molding machine. The dimensions of the mold were 80 mm in length, 10 mm in width, and 4 mm in thickness. After a sample was removed from the mold and was cooled at 25° C. for 10 hours, the length, width, and thickness of the sample were measured to calculate the cubic content of the molded product. The mold shrinkage factor was calculated using the following formula.

Mold shrinkage factor (%)=((the cubic content of the mold cavity−the cubic content of the molded product)/the cubic content of the mold cavity)×100

A mold shrinkage factor of 0.6% or less was good and rated A. A mold shrinkage factor of more than 0.6% was rated B.

### Method for Measuring Residual Magnetic Flux Density

The residual magnetic flux density was measured in a resin molded body. The measurement was performed at 25° C. with a vibrating sample magnetometer (VSM-5HSC manufactured by Toei Industry Co., Ltd.). An external magnetic field of 1195 kA/m was applied to the molded body in the orientation direction. The residual magnetic flux density can also be measured in pellets of a resin composition.

A residual magnetic flux density of 2700 G or more was sufficient magnetic characteristics and was rated A. A residual magnetic flux density of less than 2700 G was rated B.

### Method for Measuring Non-Magnetic Powder Content

A resin in the resin composition was dissolved in a solvent, and a supernatant was removed by centrifugation. A precipitate was washed several times with a volatile solvent, such as ethanol, and was thoroughly dried. A magnetic powder was magnetically separated with a permanent magnet from the dried precipitate to isolate a non-magnetic powder. The dry-process automatic densitometer (AccuPyc 1330 manufactured by Micromeritics Instrument Corporation) was used to measure the cubic content of the non-magnetic powder. The cubic content of the non-magnetic powder and the cubic content of the sample were compared to calculate the non-magnetic powder content.

### Exemplary Embodiment 1

### Preparation of Resin Composition

A thermoplastic resin (A-1), polyamide 12 (UBESTA 3012U manufactured by Ube Industries, Ltd.), was prepared as a resin. A rare-earth magnetic powder, a Nd—Fe—B magnetic powder (B-1) (MQP-10-8.5HD manufactured by Magnequench), was prepared as a magnetic powder. The apparent density of fly ash balloons (Cenolite manufactured by Tomoe Engineering Co., Ltd.) was adjusted to 0.82 g/cm³ with a weight classifier to prepare a powder (C-1) as a non-magnetic powder.

These components were mixed in a Henschel mixer for 10 minutes at a blend ratio of (A-1) 23.3% by volume, (B-1) 56.8% by volume, and (C-1) 19.9% by volume to prepare a mixture. The mixture was kneaded in a kneading machine (a twin-screw kneader PCM-30 manufactured by Ikegai Corporation) coupled to a hot-cut apparatus to prepare pellets of the resin composition.

### Preparation of Resin Molded Body

The resin composition pellets were molded with an injection molding machine into a rectangular parallelepiped 80 mm in length, 10 mm in width, and 4 mm in thickness while applying a magnetic field of 50 kA/m to the mold to align the crystal orientation of the magnetic powder. The cylinder temperature was 290° C., and the mold temperature was 150° C. Thus, a resin molded body according to Exemplary Embodiment 1 was prepared.

### Evaluation

The residual magnetic flux density of the resin molded body according to Exemplary Embodiment 1 was measured to be 3200 G, which was good magnetic characteristics. The mold shrinkage factor was measured to be 0.2%.

A molded body with a known cubic content (3.19 cm³) was dissolved in hexafluoroisopropanol and was centrifuged to remove a supernatant. A precipitate was washed several times with ethanol and was thoroughly dried. A magnetic powder was magnetically separated with a permanent magnet from the dried precipitate to isolate a non-magnetic powder. The cubic content of the non-magnetic powder was measured to be 0.64 cm³, and the non-magnetic powder constituted 19.9% by volume of the molded body.

### Exemplary Embodiments 2 to 15

Exemplary Embodiment 2 was different from Exemplary Embodiment 1 in that Cenolite (C-2) with an apparent density adjusted to 0.70 g/cm³ using a weight classifier was used instead of (C-1). Except for this, a resin molded body according to Exemplary Embodiment 2 was prepared in the same manner as in Exemplary Embodiment 1.

Exemplary Embodiment 3 was different from Exemplary Embodiment 1 in that Cenolite (C-3) with an apparent density adjusted to 1.00 g/cm³ using a weight classifier was used instead of (C-1). Except for this, a resin molded body according to Exemplary Embodiment 3 was prepared in the same manner as in Exemplary Embodiment 1.

Exemplary Embodiment 4 was different from Exemplary Embodiment 1 in that the amount of (A-1) was 35.2% by volume and the amount of (C-1) was 8.0% by volume. Except for this, a resin molded body according to Exemplary Embodiment 4 was prepared in the same manner as in Exemplary Embodiment 1.

Exemplary Embodiment 5 was different from Exemplary Embodiment 1 in that the amount of (A-1) was 8.2% by volume and the amount of (C-1) was 35.0% by volume. Except for this, a resin molded body according to Exemplary Embodiment 5 was prepared in the same manner as in Exemplary Embodiment 1.

Exemplary Embodiment 6 was different from Exemplary Embodiment 1 in that a thermoplastic resin polyamide 6 (A-2) was used as a resin instead of (A-1). Except for this, a resin molded body according to Exemplary Embodiment 6 was prepared in the same manner as in Exemplary Embodiment 1.

Exemplary Embodiment 7 was different from Exemplary Embodiment 1 in that a thermoplastic resin, a poly(phenylene sulfide) (A-3), was used as a resin instead of (A-1). Except for this, a resin molded body according to Exemplary Embodiment 7 was prepared in the same manner as in Exemplary Embodiment 1.

Exemplary Embodiment 8 was different from Exemplary Embodiment 1 in that shirasu (a type of light gray volcanic ash) balloons (C-4) were used as a non-magnetic powder instead of (C-1). Except for this, a resin molded body according to Exemplary Embodiment 8 was prepared in the same manner as in Exemplary Embodiment 1.

Exemplary Embodiment 9 was different from Exemplary Embodiment 1 in that polyester hollow particles (C-5) were used as a non-magnetic powder instead of (C-1). Except for this, a resin molded body according to Exemplary Embodiment 9 was prepared in the same manner as in Exemplary Embodiment 1.

Exemplary Embodiment 10 was different from Exemplary Embodiment 1 in that phenolic resin hollow particles (C-6) were used as a non-magnetic powder instead of (C-1). Except for this, a resin molded body according to Exemplary Embodiment 10 was prepared in the same manner as in Exemplary Embodiment 1.

Exemplary Embodiment 11 was different from Exemplary Embodiment 1 in that each material was supplied to a kneading machine by a weight feeder without mixing in a Henschel mixer. Except for this, a resin molded body according to Exemplary Embodiment 11 was prepared in the same manner as in Exemplary Embodiment 1.

Exemplary Embodiment 12 was different from Exemplary Embodiment 1 in that the kneading machine was a Φ40-mm single-screw extruder manufactured by Placo Co., Ltd. Except for this, a resin molded body according to Exemplary Embodiment 12 was prepared in the same manner as in Exemplary Embodiment 1.

Exemplary Embodiment 13 was different from Exemplary Embodiment 1 in that a water tank and a cold-cut pelletizer were used instead of the hot-cut apparatus. Except for this, a resin molded body according to Exemplary Embodiment 13 was prepared in the same manner as in Exemplary Embodiment 1.

Exemplary Embodiment 14 was different from Exemplary Embodiment 13 in that a water-cooling conveyor was used instead of the water tank. Except for this, a resin molded body according to Exemplary Embodiment 14 was prepared in the same manner as in Exemplary Embodiment 1.

Exemplary Embodiment 15 was different from Exemplary Embodiment 1 in that a kneader was used as a kneading machine and the resulting mixture was ground. Except for this, a resin molded body according to Exemplary Embodiment 15 was prepared in the same manner as in Exemplary Embodiment 1.

### Comparative Example 1

Comparative Example 1 was different from Exemplary Embodiment 1 in that soda-lime borosilicate glass (C-7) with an apparent density of 0.60 g/cm³ was used as a non-magnetic powder instead of (C-1). Except for this, a resin molded body according to Comparative Example 1 was prepared in the same manner as in Exemplary Embodiment 1.

### Comparative Example 2

Comparative Example 2 was different from Exemplary Embodiment 1 in that fly ash balloons (C-8) with an apparent density adjusted to 1.10 g/cm³ using a weight classifier were used instead of (C-1). Except for this, a resin molded body according to Comparative Example 2 was prepared in the same manner as in Exemplary Embodiment 1.

### Comparative Example 3

Comparative Example 3 was different from Exemplary Embodiment 1 in that the amount of (A-1) was 38.2% by volume and the amount of (C-1) was 5.0% by volume. Except for this, a resin molded body according to Comparative Example 3 was prepared in the same manner as in Exemplary Embodiment 1.

### Comparative Example 4

Comparative Example 4 was different from Exemplary Embodiment 1 in that the amount of (A-1) was 2.2% by volume and the amount of (C-1) was 41.0% by volume. Except for this, a resin molded body according to Comparative Example 4 was prepared in the same manner as in Exemplary Embodiment 1.

### Comparative Example 5

Comparative Example 5 was different from Exemplary Embodiment 13 in that the amount of (A-1) was 48.2% by volume, 51.8% by volume of a rare-earth magnetic powder Nd—Fe—B (B-2) was used as a magnetic powder instead of (B-1), and the non-magnetic powder was not used. Except for this, a resin molded body according to Comparative Example 5 was prepared in the same manner as in Exemplary Embodiment 13.

### Comparative Example 6

Comparative Example 6 was different from Comparative Example 5 in that the amount of (A-1) was 43.2% by volume and the amount of (B-2) was 56.8% by volume. Except for this, a resin molded body according to Comparative Example 6 was prepared in the same manner as in Comparative Example 5.

### Comparative Example 7

Comparative Example 7 was different from Comparative Example 5 in that the amount of (A-1) was 37.3% by volume and the amount of (B-2) was 62.7% by volume. Except for this, a resin molded body according to Comparative Example 7 was prepared in the same manner as in Comparative Example 5.

### Comparative Example 8

Comparative Example 8 was different from Comparative Example 6 in that a rare-earth magnetic powder Nd—Fe—B (B-3) was used instead of (B-2). Except for this, a resin molded body according to Comparative Example 8 was prepared in the same manner as in Comparative Example 6.

### Comparative Example 9

Comparative Example 9 was different from Comparative Example 6 in that a rare-earth magnetic powder Nd—Fe—B (B-4) was used instead of (B-2). Except for this, a resin molded body according to Comparative Example 9 was prepared in the same manner as in Comparative Example 6.

### Comparative Example 10

Comparative Example 10 was different from Comparative Example 6 in that a thermoplastic resin polyamide 12 (A-4) was used instead of (A-1). Except for this, a resin molded body according to Comparative Example 10 was prepared in the same manner as in Comparative Example 6.

### EVALUATION RESULTS

Table 1 summarizes the resin, magnetic powder, and non-magnetic powder contents of Exemplary Embodiments 1 to 15 and Comparative Examples 1 to 10.

TABLE 1

| | Resin | | Magnetic powder | | Non-magnetic powder | | |
|---|---|---|---|---|---|---|---|
| | | Content | | Content | | Content | Apparent |
| | | (% by | | (% by | | (% by | density |
| | Type | volume) | Type | volume) | Type | volume) | (g/cm³) |
| Exemplary Embodiment 1 | A-1 | 23.3 | B-1 | 56.8 | C-1 | 19.9 | 0.82 |
| Exemplary Embodiment 2 | A-1 | 23.3 | B-1 | 56.8 | C-2 | 19.9 | 0.70 |
| Exemplary Embodiment 3 | A-1 | 23.3 | B-1 | 56.8 | C-3 | 19.9 | 1.00 |
| Exemplary Embodiment 4 | A-1 | 35.2 | B-1 | 56.8 | C-1 | 8.0 | 0.82 |
| Exemplary Embodiment 5 | A-1 | 8.2 | B-1 | 56.8 | C-1 | 35.0 | 0.82 |
| Exemplary Embodiment 6 | A-2 | 23.3 | B-1 | 56.8 | C-1 | 19.9 | 0.82 |
| Exemplary Embodiment 7 | A-3 | 23.3 | B-1 | 56.8 | C-1 | 19.9 | 0.82 |
| Exemplary Embodiment 8 | A-1 | 23.3 | B-1 | 56.8 | C-4 | 19.9 | 0.82 |
| Exemplary Embodiment 9 | A-1 | 23.3 | B-1 | 56.8 | C-5 | 19.9 | 0.84 |
| Exemplary Embodiment 10 | A-1 | 23.3 | B-1 | 56.8 | C-6 | 19.9 | 0.79 |
| Exemplary Embodiment 11 | A-1 | 23.3 | B-1 | 56.8 | C-1 | 19.9 | 0.82 |
| Exemplary Embodiment 12 | A-1 | 23.3 | B-1 | 56.8 | C-1 | 19.9 | 0.82 |
| Exemplary Embodiment 13 | A-1 | 23.3 | B-1 | 56.8 | C-1 | 19.9 | 0.82 |
| Exemplary Embodiment 14 | A-1 | 23.3 | B-1 | 56.8 | C-1 | 19.9 | 0.82 |
| Exemplary Embodiment 15 | A-1 | 23.3 | B-1 | 56.8 | C-1 | 19.9 | 0.82 |
| Comparative Example 1 | A-1 | 23.3 | B-1 | 56.8 | C-7 | 19.9 | 0.60 |
| Comparative Example 2 | A-1 | 23.3 | B-1 | 56.8 | C-8 | 19.9 | 1.10 |
| Comparative Example 3 | A-1 | 38.2 | B-1 | 56.8 | C-1 | 5.0 | 0.82 |
| Comparative Example 4 | A-1 | 2.2 | B-1 | 56.8 | C-1 | 41.0 | 0.82 |
| Comparative Example 5 | A-1 | 48.2 | B-2 | 51.8 | — | 0.0 | — |
| Comparative Example 6 | A-1 | 43.2 | B-2 | 56.8 | — | 0.0 | — |
| Comparative Example 7 | A-1 | 37.3 | B-2 | 62.7 | — | 0.0 | — |
| Comparative Example 8 | A-1 | 43.2 | B-3 | 56.8 | — | 0.0 | — |
| Comparative Example 9 | A-1 | 43.2 | B-4 | 56.8 | — | 0.0 | — |
| Comparative Example 10 | A-4 | 43.2 | B-2 | 56.8 | — | 0.0 | — |

Table 2 summarizes the magnetic characteristics and mold shrinkage factors of the resin molded bodies according to Exemplary Embodiments 1 to 15 and Comparative Examples 1 to 10.

TABLE 2

| | Residual | | Mold | |
|---|---|---|---|---|
| | magnetic | | shrinkage | |
| | flux density | | factor | |
| | (G) | Rating | (%) | Rating |
| Exemplary Embodiment 1 | 3200 | A | 0.2 | A |
| Exemplary Embodiment 2 | 2850 | A | 0.2 | A |
| Exemplary Embodiment 3 | 2830 | A | 0.2 | A |
| Exemplary Embodiment 4 | 3290 | A | 0.5 | A |
| Exemplary Embodiment 5 | 2920 | A | 0.1 | A |
| Exemplary Embodiment 6 | 3130 | A | 0.2 | A |
| Exemplary Embodiment 7 | 3010 | A | 0.2 | A |
| Exemplary Embodiment 8 | 2920 | A | 0.2 | A |
| Exemplary Embodiment 9 | 2900 | A | 0.2 | A |
| Exemplary Embodiment 10 | 2870 | A | 0.3 | A |
| Exemplary Embodiment 11 | 3180 | A | 0.2 | A |
| Exemplary Embodiment 12 | 3230 | A | 0.2 | A |
| Exemplary Embodiment 13 | 3150 | A | 0.2 | A |
| Exemplary Embodiment 14 | 3200 | A | 0.2 | A |
| Exemplary Embodiment 15 | 3190 | A | 0.2 | A |
| Comparative Example 1 | 2630 | B | 0.4 | A |
| Comparative Example 2 | 2600 | B | 0.2 | A |
| Comparative Example 3 | 3310 | A | 1.0 | B |
| Comparative Example 4 | — | B | — | B |
| Comparative Example 5 | 2840 | A | 1.3 | B |
| Comparative Example 6 | 3120 | A | 1.2 | B |
| Comparative Example 7 | 3430 | A | 1.0 | B |
| Comparative Example 8 | 3345 | A | 1.2 | B |
| Comparative Example 9 | 3080 | A | 1.2 | B |
| Comparative Example 10 | 3100 | A | 1.1 | B |

Alphanumeric characters in the columns “Type” in Table 1 mean the following.

### (A) Resin

A-1: UBESTA 3012U (polyamide 12) manufactured by Ube Industries, Ltd.

A-2: Unitika Nylon 6 A1015LP-20 (polyamide 6) manufactured by Unitika Ltd.

A-3: Ryton (registered trademark) QA200N (poly(phenylene sulfide)) manufactured by Solvay Specialty Polymers Japan K.K.

A-4: Diamid ZZ3000P (polyamide 12) manufactured by Daicel-Evonik Ltd.

### (B) Magnetic Powder

B-1: MQP-10-8.5HD (a Nd—Fe—B magnetic powder) manufactured by Magnequench

B-2: YMM9-6 (a Nd—Fe—B magnetic powder) manufactured by Yuhong Magnetic Materials Co. Ltd.

B-3: YMM-H13-9 (a Nd—Fe—B magnetic powder) manufactured by Yuhong Magnetic Materials Co. Ltd.

B-4: ZRK-B-8.5M (a Nd—Fe—B magnetic powder) manufactured by Zhe Jiang Zhao-Ri-Ke Magnet Industries Co., Ltd.

### (C) Non-Magnetic Powder

C-1: Cenolite (fly ash balloons, apparent density: 0.82 g/cm³) manufactured by Tomoe Engineering Co., Ltd.

C-2: Cenolite (fly ash balloons, apparent density: 0.70 g/cm³) manufactured by Tomoe Engineering Co., Ltd.

C-3: Cenolite (fly ash balloons, apparent density: 1.0 g/cm³) manufactured by Tomoe Engineering Co., Ltd.

C-4: Maarlite BA15 (shirasu balloons, apparent density: 0.82 g/cm³) manufactured by Marunakahakudo Inc.

C-5: Kureha Sphere H (polyester, apparent density: 0.84 g/cm³) manufactured by Kureha Corporation

C-6: Phenolic Microballoons (phenol, apparent density: 0.79 g/cm³) manufactured by Union Carbide Corporation

C-7: im³0 K (soda lime borosilicate glass, apparent density: 0.60 g/cm³) manufactured by 3M Co.

C-8: Cenolite (fly ash balloons, apparent density: 1.1 g/cm³) manufactured by Tomoe Engineering Co., Ltd.

The residual magnetic flux densities and mold shrinkage factors of the resin molded bodies prepared in Exemplary Embodiments 1 to 15 were rated A (good). By contrast, at least one of the residual magnetic flux density and the mold shrinkage factor of each resin molded body prepared in Comparative Examples 1 to 10 was rated B.

Comparative Example 1, in which the non-magnetic powder had an apparent density of less than 0.70 g/cm³, had a small residual magnetic flux density.

Comparative Example 2, in which the non-magnetic powder had an apparent density of more than 1.0 g/cm³, had a small residual magnetic flux density.

Comparative Example 3 had a large mold shrinkage factor due to a low non-magnetic powder content of 8% or less by volume.

Comparative Example 4 had increased viscosity and could not be pelletized due to a non-magnetic powder content of 40% or more by volume and a low resin content.

These results show that a resin molded body with good magnetic characteristics and high dimensional accuracy can be provided when the non-magnetic powder has an apparent density in the range of 0.70 to 1.0 g/cm³, and the non-magnetic powder content is more than 8% by volume and 40% or less by volume.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-054920 filed Mar. 29, 2021, which is hereby incorporated by reference herein in its entirety.

What is claimed is:

1. A resin molded body comprising:
a resin;
a magnetic powder; and
a non-magnetic powder,
wherein the non-magnetic powder has an apparent density in the range of 0.70 to 1.0 g/cm³, and
the non-magnetic powder content is more than 8% by volume and 40% or less by volume.

2. The resin molded body according to claim 1, wherein the non-magnetic powder is composed of inorganic particles.

3. The resin molded body according to claim 2, wherein the inorganic particles are at least one member selected from the group consisting of alumina silicate hollow particles, alumina hollow particles, silica hollow particles, mullite hollow particles, and fly ash balloons.

4. The resin molded body according to claim 3, wherein the inorganic particles are fly ash balloons.

5. The resin molded body according to claim 1, wherein the resin content ranges from 8% to 40% by volume.

6. The resin molded body according to claim 1, wherein the resin is a thermoplastic resin.

7. The resin molded body according to claim 6, wherein the thermoplastic resin is a polyamide.

8. The resin molded body according to claim 1, wherein the magnetic powder content ranges from 40% to 70% by volume.

9. The resin molded body according to claim 1, wherein the magnetic powder is a ferrite magnetic powder and/or a rare-earth magnetic powder.

10. An article comprising the resin molded body according to claim 1.

11. A method of manufacturing a resin molded body, comprising the steps of:
preparing a resin, a magnetic powder, and a non-magnetic powder with an apparent density in the range of 0.70 to 1.0 g/cm³;
preparing a resin composition by mixing the resin, the magnetic powder, and the non-magnetic powder such that the non-magnetic powder content is more than 8% by volume and 40% or less by volume;
melting and molding the resin composition to prepare a resin molded body; and
applying a magnetic field to the resin composition and/or the resin molded body.

12. A resin composition comprising:
a resin;
a magnetic powder; and
a non-magnetic powder;
wherein the non-magnetic powder has an apparent density in the range of 0.70 to 1.0 g/cm³, and
the non-magnetic powder content is more than 8% by volume and 40% or less by volume.
